(19) United States
(12) Patent Application Publication
(10) Pub. No.: US 2008/0225415 A1
(43) Pub. Date: Sep. 18, 2008

(54) Actuated stepper lens camera module

(76) Inventors: Elaine B. Bogue, Dunstable, MA (US); Ray H. Morton, New Braunfels, TX (US)

Correspondence Address: HENNEMAN & ASSOCIATES, PLC, 714 W. MICHIGAN AVENUE, THREE RIVERS, MI, 49093, US

(21) Appl. No.: 11/998,992

(22) Filed: Dec. 3, 2007

Related U.S. Application Data
(60) Provisional application No. 60/872,142, filed on Dec. 1, 2006.

(51) Int. Cl. G02B 7/02

(52) U.S. Cl. 359/824

(57) ABSTRACT

A camera module includes an integral motor for rotating a lens unit of the camera module within a housing of the camera module. The housing includes a plurality of electromagnetic coils that function as a stator of the motor. The lens unit includes a plurality of ferrite elements and functions as a rotor of the motor. Rotation of the lens unit within the housing causes focal adjustment, such that the motor can be used as a component of an auto-focus system. A method for assembling the camera module is also disclosed.

### CROSS-REFERENCE TO RELATED APPLICATIONS

This application claims the benefit of copending U.S. Provisional Patent Application No. 60/872,142 filed Dec. 1, 2006 by the same inventors, which is incorporated herein by reference in its entirety.

### BACKGROUND

1. Field of the Invention

The present invention relates generally to electronic devices, and more particularly to digital camera modules. Even more particularly, the present invention relates to a system for focusing a digital camera module via a stepper motor incorporated therein.

2. Description of the Background Art

Digital camera modules are currently being incorporated into a variety of electronic devices. Such camera hosting devices include, but are not limited to, cellular telephones, personal data assistants (PDAs), and computers. The demand for digital camera modules continues to grow as the ability to incorporate the camera modules into host devices expands. Therefore, one design goal of digital camera modules is to make them as small as possible so that they will fit into an electronic device without substantially increasing the overall size of the device. Furthermore, it is also desirable to manufacture such digital camera modules as efficiently and robustly as possible. It is also desirable to manufacture digital camera modules that require minimal user knowledge and effort to operate. Means for achieving these design goals should enhance, or at least preserve, the quality of the image captured by the camera modules.

Typically, camera modules include multiple focal modes for focusing on images at various distances. For example, known camera modules include multiple modes for focusing images of objects at different distances. Changing from one mode to another requires a change in displacement between a lens and an image capture device within the camera module. This displacement change is facilitated by many different mechanisms known to those skilled in the art. For example, many prior art camera modules include a threaded lens housing that is threaded into and out of an image capture device housing, thereby changing the distance between the lens and the image capture device. Other commonly known focusing devices include cam mechanisms to move the lens with respect to the image capture device.

In miniature camera modules, prior art focusing methods are typically accomplished manually, because the size limitations prohibit the use of drive motors, cams, gears, and so on. In addition, prior art devices include other disadvantages. For example, some prior art camera modules have only two focal modes, micro and macro. Thus, image quality is sacrificed at intermediate ranges. Another disadvantage is that the user is inconvenienced by having to make sure the camera is in the correct focal mode and/or switching the focal modes. The extremely small size of some camera modules makes manual focal adjustment even more difficult.

What is needed, therefore, is a camera module that provides many focal modes and/or continuous focal adjustment. What is also needed is a camera module that requires minimal user effort and knowledge to operate. What is also needed is a camera module that can be automatically focused. What is also needed is a camera module that provides focusing flexibility, while remaining relatively small in size.

### SUMMARY

The present invention overcomes problems of the prior art by providing a means for incorporating a drive motor into a camera module. The drive motor is suitable for use in even extremely small camera modules, because components of the camera module also serve as components of the motor.

In one embodiment a camera module includes an image capture device, a lens unit, a housing, an electrical motor, and an adjustment (e.g., focus, zoom, etc.) mechanism. The housing is adapted to receive the lens unit and to position the lens unit with respect to the image capture device. The housing forms a first portion of the electrical motor, and the lens unit forms a second portion of the electrical motor. When the electrical motor is energized, the lens unit rotates within the housing.

In a particular embodiment, the motor is a stepper motor. The portion of the motor formed by the housing is a stator of the stepper motor, and the portion of the motor formed by the lens unit is a rotor of the stepper motor. The lens unit includes a generally cylindrical body with a plurality of ferrite elements fixed to the cylindrical body. The housing includes a plurality of electrical windings that electromagnetically attract the ferrite elements when energized.

An example adjustment mechanism includes a plurality of ramps formed on the housing and a plurality of complementary ramps formed on the lens unit. When the lens unit rotates within the housing the adjustment mechanism changes the position of the lens unit with respect to the image capture device. Optionally, the complementary ramps are formed on an annular ring of the lens unit, and the lens unit includes a second adjustment mechanism between another portion of the annular ring and the cylindrical body of the lens unit. The first adjustment mechanism (between the ring and the housing) facilitates focusing by the motor. The second adjustment mechanism (between the ring and the cylindrical body of the lens unit) facilitates a factory focus operation.

According to another aspect of the invention, a camera focusing motor is provided for use in various types of cameras and/or camera modules. The camera focusing motor includes a stator formed integrally with a housing of the camera and a rotor formed integrally with the lens unit of the camera. The rotor includes a lens barrel of the lens unit and a plurality of ferrite elements embedded in the lens barrel. The stator includes a plurality of electromagnetic coils mounted in the housing. The individual coils are disposed adjacent the periphery of the lens barrel so that the plurality of electromagnetic coils surrounds the lens barrel of the lens unit. Control circuitry selectively energizes the electromagnetic coils to control the rotational movement of the rotor with respect to the stator. Optionally, at least a portion of the control circuitry is included in an integrated image capture device mounted with respect to the housing. In the example shown, the motor functions as a stepper motor.

A method for assembling a camera module is also disclosed. The method includes providing a housing including a first portion of a motor, providing a housing including a second portion of a motor, and positioning the lens unit with respect to the housing to engage the first portion of the motor with the second portion of the motor. The step of providing the housing with a first portion of the motor includes providing a housing with a plurality of electromagnetic coils fixed thereto. Thus, a stator of the motor is built into the housing. The step of providing the lens unit includes providing a lens unit with a plurality of ferrite elements fixed thereto. Thus, the rotor of the motor is built into the lens unit. In the disclosed example method, the assembled camera module operates as a stepper motor.

### BRIEF DESCRIPTION OF THE DRAWINGS

The present invention is described with reference to the following drawings, wherein like reference numbers denote substantially similar elements:

FIG. 1 is a perspective view of a camera module;

FIG. 2 is an exploded perspective view of the camera module of FIG. 1;

FIG. 3 is a perspective cross-sectional view of the lens barrel shown in FIG. 1;

FIG. 4 is a perspective view of the camera module housing shown in FIG. 1;

FIG. 5 is a rear perspective view of the interior of the housing shown in FIG. 1;

FIG. 6 is a cross-sectional view of the camera module shown in FIG. 1;

FIG. 7 is flow chart summarizing a method for assembling a camera module; and

FIG. 8 is a flow chart summarizing another method for assembling a camera module.

### DETAILED DESCRIPTION

The present invention overcomes the problems associated with the prior art, by providing a camera module with a stepper motor incorporated therein. In the following description, numerous specific details are set forth (e.g., material selection) in order to provide a thorough understanding of the invention. Those skilled in the art will recognize, however, that the invention may be practiced apart from these specific details. In other instances, details of well known electrical practices (e.g., stepper motor assembly and control, etc.) and components have been omitted, so as not to unnecessarily obscure the present invention. Such details can be found in references generally known to those skilled in the art. For example, Acarnley, Paul P., Stepping Motors: A Guide to Theory and Practice, 4^{th} edition, (IEE Control Engineering Series, 63) provides useful information regarding the operation of stepper motors. That reference is incorporated herein by reference in its entirety.

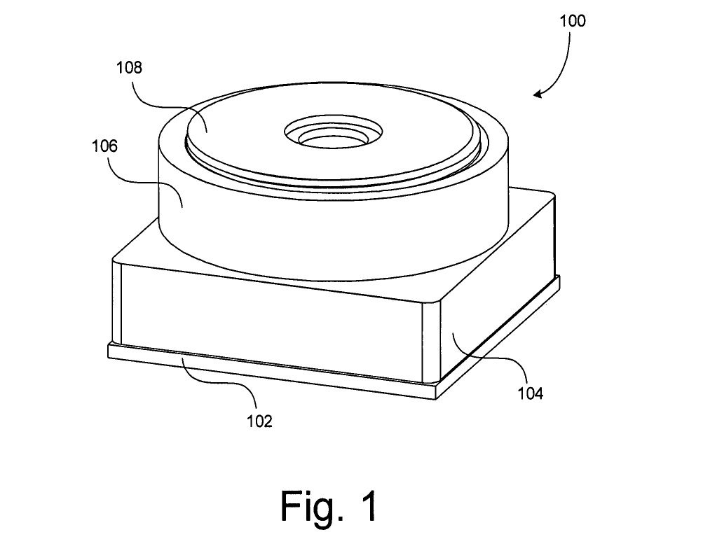

FIG. 1 shows a perspective view of an assembled digital camera module 100. In this particular embodiment, camera module 100 includes a printed circuit board (PCB) 102, a housing 104, an actuating ring 106, and a lens barrel 108. In this particular embodiment, camera module 100 also includes an autofocus feature wherein lens barrel 108 is vertically displaceable with respect to PCB 102 via an electro-magnetically driven system (e.g., stepper motor).

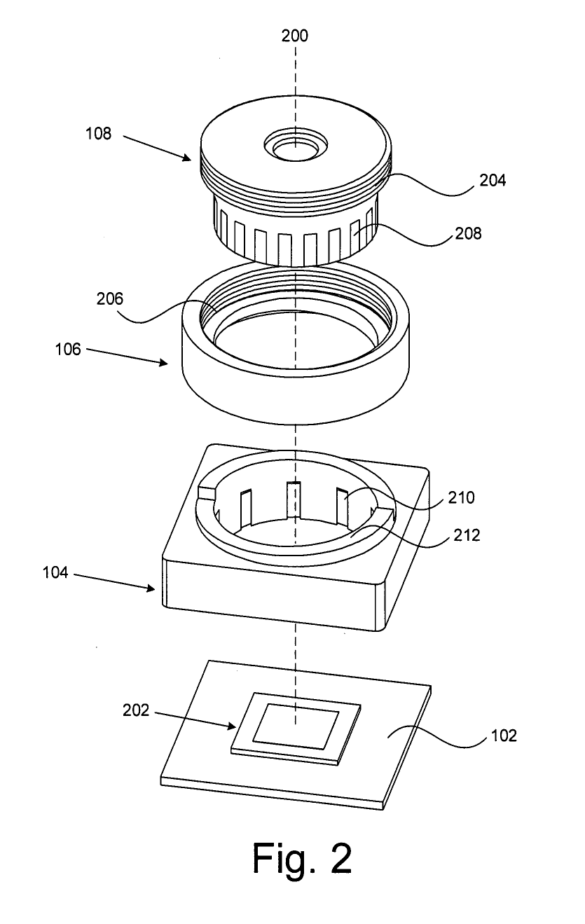

FIG. 2 shows a perspective view of camera module 100 exploded along an optical axis 200. As shown, PCB 102 includes an image capture device 202 affixed thereon. PCB 102 is further affixed to the rear surface of housing 104 so as to provide support to actuating ring 106. In this particular embodiment, actuating ring 106 is rotatable about optical axis 200. Lens barrel 108 includes a threaded peripheral surface 204 that threads into a complimentary threaded inner portion 206 of actuating ring 106. Threads 204 and 206 enable lens barrel 108 to be properly focused with respect to actuating ring 106. This particular focusing feature is typically carried out during the manufacturing process and is typically only done one time. This is commonly referred to as factory focusing.

The autofocus feature is different than the factory focusing carried out during the manufacturing of camera module 100. The autofocus feature enables the focal field to be changed anytime either by the user or automatically by autofocusing means known to those skilled in the art. The autofocus mechanism works using the same principle as a stepper motor. In the center of camera module 100 is lens barrel 108 which includes ferrite elements 208 embedded into it's peripheral surface. Barrel 108 acts as the “rotor”. Housing 104 includes magnetic windings 210 (electromagnetic coils) that function as a “stator”. As windings 210 are given power (energized), ferrite elements 208 become electromagnetically attracted to windings 210. As a result, actuation ring 106 and lens barrel 108 (fixed within ring 106 during factory focusing) are rotated in a direction that depends on which of windings 210 are given power. As ring 106 rotates, it slidably contacts a sloped surface 212 of housing 104, which changes the vertical distance between lens barrel 108 and image capture device 202. Of course, this vertical distance change between lens barrel 108 and image capture device 202 facilitates the focusing of camera module 100.

In this particular embodiment, the control circuitry for the stepper motor is included in image capture device 202. The power circuitry and electrical interconnections are not shown, so as to not unnecessarily obscure the description invention. However, those skilled in the art will understand that such circuitry would reside on PCB 102 and an electrical interconnection between PCB 102 and housing 104 would be provided in order to route power to windings 210.

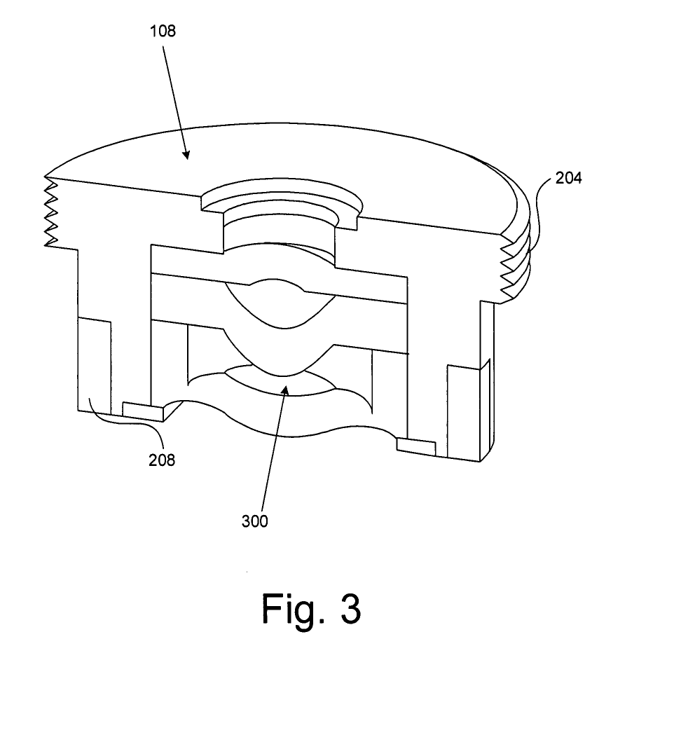

FIG. 3 shows a cross-sectional perspective view of lens barrel 108. In this particular embodiment, lens barrel 108 houses a lens assembly 300. It should be apparent to those skilled in the art that specifications (e.g., prescription, IR filters, fixing means, etc.) of lens assembly 300 are not essential aspects of the present invention and are only shown to provide a better understanding of the present invention.

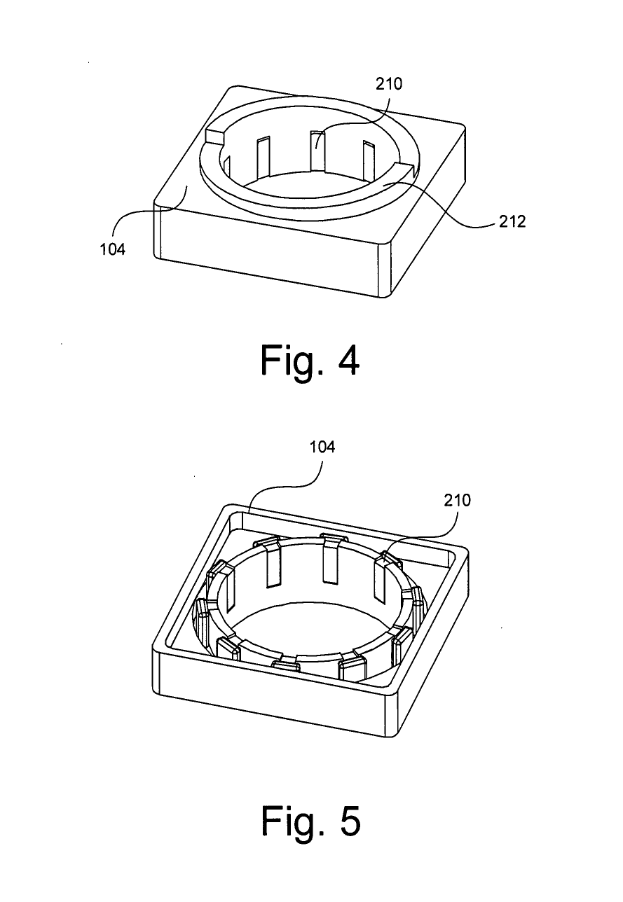

FIG. 4 is a top perspective view of housing 104. In this particular embodiment, housing 104 includes sloped surfaces 212 (ramps) that slidably engage the rear surface (complementary ramps) of actuating ring 106. As lens barrel 108 is rotated by the electromagnetic force between ferrite elements 208 and windings 210, sloped surface 212 facilitates the change in distance between lens assembly 300 and image capture device 202.

FIG. 5 is a bottom perspective view of housing 104. This particular figure illustrates how windings 210 are built into the interior of housing 104.

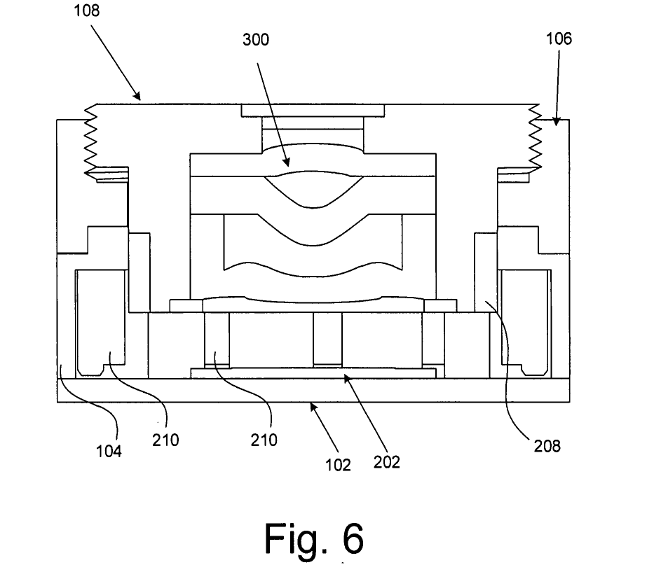

FIG. 6 is cross-sectional view of camera module 100, showing the relative positioning of lens barrel 108 and housing 104 when lens barrel 108 is mounted to housing 104. Note that the individual windings 210 are each disposed adjacent the periphery of lens barrel 108 such that the plurality of windings 210 surrounds lens barrel 108. Lens barrel 108 and housing 104 actually form a portion of the electrical motor used to provide focal adjustment. In particular, lens barrel 108 forms a portion of a rotor, and housing 104 actually forms a portion of a stator.

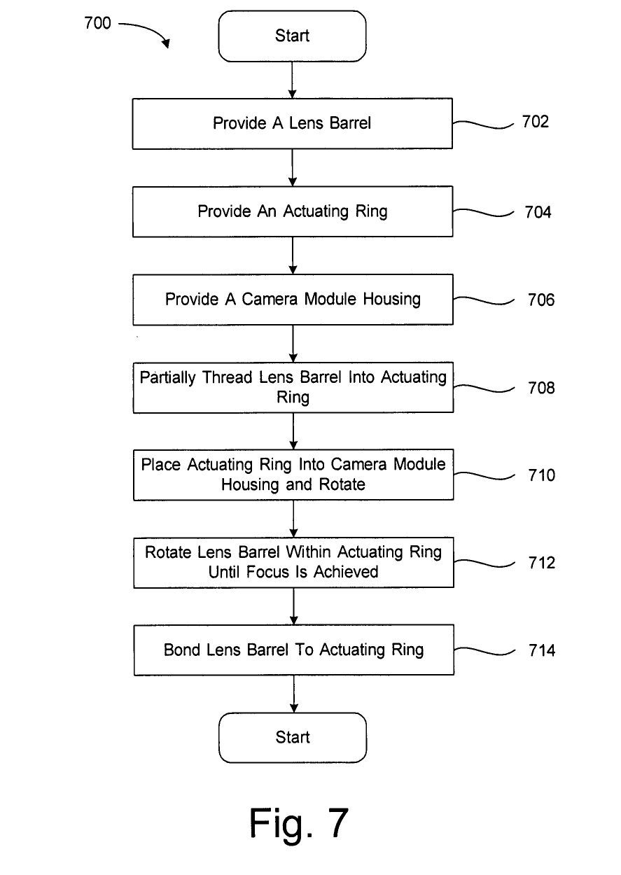

FIG. 7 is a flow chart summarizing one particular method 700 for assembling a camera module. In a first step 702, a lens barrel is provided. Next, in a second step 704, an actuating ring is provided. Then, in a third step 706, a camera module housing is provided. Next, in a fourth step 708, the lens barrel is partially thread into the actuating ring. Then, in a fifth step 710, the actuating ring is placed into the housing and rotated up against a stop for calibration. Next, in a sixth step 712, with the actuating ring held against the stop, the lens barrel is rotated within the actuating ring until focus is achieved (factory focus). Finally, in a seventh step 714, the lens barrel is bonded to the actuating ring.

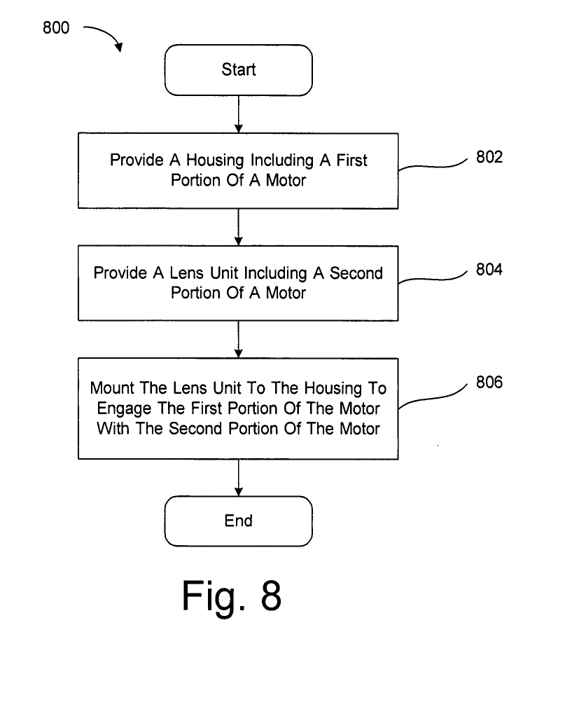

FIG. 8 is a flow chart summarizing another particular method 800 of assembling a camera module. In a first step 802, a camera module housing including a first portion of a motor is provided. Then, in a second step 804, a lens unit including a second portion of the motor is provided. Next, in a third step 806, the lens unit is mounted to the camera housing to engage the first portion of the motor to the second portion of the motor. Thus, the assembly of a camera module and the assembly of the motor occur simultaneously.

The description of particular embodiments of the present invention is now complete. Many of the described features may be substituted, altered or omitted without departing from the scope of the invention. For example, alternate lens assemblies may be substituted for lens assembly 300. As another example, alternate adjustment mechanisms (e.g. threads, grooves, etc.) can be substituted for sloped surface 212. These and other deviations from the particular embodiments shown will be apparent to those skilled in the art, particularly in view of the foregoing disclosure.

We claim:

1. A camera module comprising:
an image capture device;
a lens unit;
a housing adapted to receive said lens unit and to position said lens unit with respect to said image capture device;
an electrical motor, said housing forming a first portion of said electrical motor and said lens unit forming a second portion of said electrical motor, said lens unit rotating within said housing when said electrical motor is energized; and
an adjustment mechanism whereby said rotation of said lens unit changes said position of said lens unit with respect to said image capture device.

2. A camera module according to claim 1, wherein:
said electrical motor is a stepper motor;
said first portion of said motor is a stator of said stepper motor; and
said second portion of said motor is a rotor of said stepper motor.

3. A camera module according to claim 2, wherein said adjustment mechanism includes:
a plurality of ramps formed on said housing; and
a plurality of complementary ramps formed on said lens unit.

4. A camera module according to claim 1, wherein said lens unit includes:
a generally cylindrical body; and
a plurality of ferrite elements fixed to said cylindrical body.

5. A camera module according to claim 4, wherein said housing includes a plurality of electrical windings that electromagnetically attract said ferrite elements when energized.

6. A camera according to claim 1, wherein:
said lens unit includes a generally cylindrical body and an annular ring;
said adjustment mechanism includes a portion of said annular ring and said housing; and
a said lens unit includes a second adjustment mechanism between another portion of said annular ring and said cylindrical body.

7. A camera module according to claim 6, wherein said lens unit includes a plurality of ferrite elements disposed about the periphery of said cylindrical body.

8. A camera focusing motor comprising:
a stator formed integrally with a housing of said camera;
a rotor formed integrally with a lens unit of said camera.

9. A camera focusing motor according to claim 8, wherein said rotor includes a lens barrel having ferrite elements embedded therein.

10. A camera focusing motor according to claim 8, wherein said stator includes a plurality of electromagnetic coils mounted in said housing.

11. A camera focusing motor according to claim 10, wherein said plurality of electromagnetic coils surrounds said lens unit.

12. A camera focusing motor according to claim 10, further comprising control circuitry operative to selectively energize said electromagnetic coils to control rotational movement of said rotor with respect to said stator.

13. A camera focusing motor according to claim 12, wherein at least a portion of said control circuitry is included in an integrated image capture device.

14. A camera focusing motor according to claim 8, wherein said motor is a stepper motor.

15. A method for assembling a camera module, said method comprising:
providing a housing including a first portion of a motor;
providing a lens unit including a second portion of a motor; and
positioning said lens unit with respect to said housing to engage said first portion of said motor with said second portion of said motor.

16. A method according to claim 15, wherein said step of providing said housing including said first portion of said motor includes providing said housing with a plurality of electromagnetic coils fixed thereto.

17. A method according to claim 15, wherein said step of providing said lens unit including said second portion of said motor includes providing said lens unit with a plurality of ferrite elements fixed thereto.

18. A method according to claim 15, wherein said step of providing said housing including said first portion of said motor includes building a stator of said motor into said housing.

19. A method according to claim 15, wherein said step of providing said lens unit including said second portion of said motor includes building a rotor of said motor into said lens unit.

20. A method according to claim 15, wherein said motor is a stepper motor.
